(19) United States
(12) Patent Application Publication
(10) Pub. No.: US 2002/0049923 A1
(43) Pub. Date: Apr. 25, 2002

(54) Method for recovering from drive failure in storage media library array apparatus

(76) Inventors: Takashi Kanazawa, Kanagawa-ken (JP); Hiroyuki Suzuki, Kanagawa-ken (JP)

Correspondence Address: David L. Fehrman, Morrison & Foerster LLP, 35th Floor, 555 W. 5th Street, Los Angeles, CA, 90013, US

(21) Appl. No.: 09/896,442

(22) Filed: Jun. 29, 2001

(30) Foreign Application Priority Data
Jul. 5, 2000 (JP) 2000-204064

(51) Int. Cl. G06F 11/00

(52) U.S. Cl. 714/5

(57) ABSTRACT

In case a drive failure has occurred in a particular drive device when a designated storage medium is being transferred into or from the particular drive device or is being mounted in the particular drive device, drive failure recover processing is carried out in predetermined order which includes: a first step of performing an operation for physically moving the storage medium relative to the particular drive device to be recovered from the drive failure; a second step of performing a reboot operation on the particular drive device; a third step of performing a hard reset operation on the particular drive device; and a fourth step of performing an operation for turning of f and then again turning on power to the particular drive device. once the particular drive device has successfully recovered from the drive failure through any of the operations of the first to fourth steps, the drive-failure recovery processing is brought to an end without performing the operation of the remaining step.

### BACKGROUND OF THE INVENTION

The present invention relates to a drive-failure recovery method for use in a media library array apparatus which comprises an array of similarly-constructed library units each including one or more drive devices for reading and/or writing data from and/or to a desired storage medium and a holder/transporter for transporting a desired storage medium to a designated place in the library unit. More particularly, the present invention concerns a technique which, when there has occurred a drive failure that can not be appropriately remedied by only reissuing a predetermined command, can appropriately remedy or recover from the drive failure promptly by automatically performing various drive-failure recovery operations other than the command reissuance.

Among various types of external storage apparatus capable of attaining high storage capacity and high performance in electronic libraries and other computer systems are the so-called disk array apparatus. Known examples of such disk array apparatus include a RAID (Redundant Array of Inexpensive Disks) apparatus, which typically comprises a plurality of magnetic disk devices arranged in an array. By operating these magnetic disk devices concurrently in a parallel manner, the RAID apparatus reads or writes data at high speed for divided data storage across the plurality of magnetic disk devices. Generally, in the disk array apparatus, calculated results (parity data) of exclusive ORs (XORs) between the data in the plurality of magnetic disk (data disk) devices are stored into an additional magnetic disk (parity disk) device other than the above-mentioned data disk devices, so as to attain high reliability against possible data trouble in the disk array apparatus. For example, in case an abnormal condition, trouble or failure occurs in a particular one of the plurality of magnetic disk devices, the disk array apparatus can use the data stored in the remaining, trouble-free or normally-functioning, disk devices and parity data to restore or reconstruct the data that have so far been stored (or were about to be stored) in the particular or failed magnetic disk device. Namely, in such a case, the data reconstruction is performed by restoring all of the data of the failed magnetic disk device from the remaining, normally-functioning disk devices and writing the thus-restored data into a newly-installed magnetic disk device or previously-installed extra (spare) magnetic disk device.

Storage apparatus capable of high capacity and relatively high performance can be implemented by a disk array apparatus using storage devices handling transportable storage media (transportable-media-type storage devices) instead of the above-mentioned magnetic disk devices. Examples of the transportable-media-type storage devices include magnetic tape devices and optical storage devices. Particularly, DVDs (Digital Versatile Disks) have been catching people's attention in recent years. These transportable-media-type storage devices are each characterized in that transportable storage media and drive devices for reading/writing data from/to the storage media are provided separately from each other and a designated one of the storage media is loaded or mounted into a desired one of the drive devices for data writing/reading on the mounted medium. Disk array system employing the transportable-media-type storage devices can also be implemented at low cost as long as the transportable storage media are inexpensive.

Further, large-scale computer systems are currently known and used which employ a storage media library in order to facilitate management of a great number of storage media such as CDs or DVDs. In these computer systems, the storage media library includes: a media entry port (hereinafter referred to as a “mass entry”) through which desired storage media are introduced into or discharged out of the library; a storage section (in some cases, also called a “magazine”) for removably storing a great number of the storage media; one or more drive devices for reading/writing data from/to (i.e., driving) a designated storage medium; and a holder/transporter for transporting a desired storage medium between the mass entry port, storage section and drive device. As the volume of data handled by the computer systems is becoming greater and greater, there is an increasing need for enhanced reliability in the data handling operations by the computer systems. Thus, in the above-mentioned storage device system comprised of transportable storage media as well, it is advantageous to achieve high reliability and high performance by applying the disk array configuration. As a technique applying the disk array configuration to transportable storage media, there have hitherto been proposed RAILs (Redundant Arrays of Inexpensive Libraries) where a plurality of the above-mentioned conventional libraries are combined into an array configuration (see DVD Applications, COMDEX 96, Nov. 20, 1996, Alan E. Bell, IBM Research Division).

In the conventionally-known storage media library array apparatus, the holder/transporter in each of the libraries takes out a necessary or designated storage medium from among a plurality of the storage media prestored in storage shelves or slots of the storage section, and automatically transports the designated storage medium to the drive device, where the transported storage medium is passed from the holder/transporter to the drive device. Then, the drive device performs a data read or write operation on the storage medium loaded or mounted in the drive device. FIG. 4 conceptually shows a manner in which the transported storage medium is passed between the holder/transporter H and the drive device 10. More specifically, section (a) of FIG. 4 is a sectional side view schematically showing a loading transfer operation by which the transported storage medium D is transferred from the holder/transporter H into the drive device 10, and (b) of FIG. 4 is a sectional side view schematically showing a loading operation by which the storage medium D is loaded into a predetermined position within the drive device 10. Further, section (c) of FIG. 4 is a sectional side view schematically showing a data read/write starting operation on the mounted storage medium D, section (d) of FIG. 4 is a sectional side view schematically showing an unloading operation by which the storage medium D is unloaded from the predetermined position within the drive device 10, and section (e) of FIG. 4 is a sectional side view schematically showing a unloading transfer operation by which the storage medium D is transferred from the drive device 10 into the holder/transporter H. Note that FIG. 4, the storage medium D is shown as passed along with its tray DT between the holder/transporter and the drive device 10.

First, the designated storage medium D is inserted into the drive device 10 in each of the libraries through the loading transfer operation as shown in section (a) of FIG. 4. Namely, in each of the libraries, the necessary or designated storage medium D is taken out from among the storage media prestored in the plurality of the storage shelves of the storage section, and is held by the holder/transporter H. The holder/transporter H with the designated storage medium D held thereby is then conveyed to a predetermined position facing an inlet/outlet of the drive device 10, so that the storage medium D is transferred from the holder/transporter H into the drive device 10 in an X direction. Once the storage medium D is fully inserted from the holder/transporter H into the drive device 10, a loader portion R within the drive device 10 is moved upward toward the medium D in a Y direction through the loading operation as shown in section (b) of FIG. 4, to thereby attach the underside of the medium D to the loader R. Then, as the loader portion R is further moved upward, a protrusion Ra, formed on the inner surface of an upper wall of the drive device 10 in opposed relation to the loader R, is fitted into a central opening of the medium D being pushed upward by the loader portion R. By thus moving the loader portion R upwardly to cause both the loader portion R and the protrusion Ra to be fitted into the central opening of the medium D, the medium D can be fixedly retained in the predetermined position within the drive device 10. The storage medium D is attached and detached to and from the loader portion R by controlling activation of a not-shown loading motor. Then, as shown in section (c) of FIG. 4, the storage medium D fixedly retained in the predetermined position within the drive device 10 is rotated by the loader portion R being rotated via a spindle motor SM, and now the medium D is ready for a data reading or writing operation. Then, once a data read/write start is instructed while the medium D attached to the loader portion R is being rotated, the data read/write operation on the medium D is initiated through the data read/write starting operation. Upon completion of the data read/write operation on the medium D, the rotation of the loader portion R is terminated and the loader portion R is moved downward in a Y′ direction away from the medium D through the unloading operation, as shown in section (d) of FIG. 4. Then, as shown in section (e) of FIG. 4, the storage medium D is discharged from the drive device 10 to be passed to the holder/transporter H in an X′ direction through the unloading transfer operation. After the holder/transporter H has received the storage medium D from the drive device 10, it transports the storage medium D back to the storage shelf where the medium D was taken out earlier.

Instruction for controlling the activation of the not-shown loading motor to move the loader portion R upward (section (b) of FIG. 4) will hereinafter called a “load command”, while an instruction for controlling the activation of the loading motor to move the loader portion R downward (section (d) of FIG. 4) will hereinafter called an “unload command”. Further, an instruction for initiating the control to perform the loading transfer (section (a) of FIG. 4) will hereinafter called a “loading transfer command”, while an instruction for initiating the control to perform the unloading transfer (section (e) of FIG. 4) will hereinafter called an “unloading transfer command”. Furthermore, an instruction for executing the control to start the data read/write operation on the medium D will hereinafter called a “data read/write start command”.

When a malfunction or failure of any one of the drive devices is detected during any one of the above-mentioned loading transfer operation, loading operation, data read/write starting operation, unloading operation and unloading transfer operation as shown in sections (a) to (e) of FIG. 4, the conventionally-known storage media library array apparatus merely reissue the predetermined command to the malfunctioning or failed drive device so as to control the drive device to again perform (re-execute) the operation which has been suspended due to the drive failure, as a process for remedying or recovering from the drive failure. For example, when a drive failure is detected during the loading transfer operation, the “loading transfer command” is reissued to re-execute the loading transfer operation as shown in section (a) of FIG. 4, or when a drive failure is detected during the loading operation as shown in section (b) of FIG. 4, the “load command” is reissued to re-execute the loading operation.

However, with the conventionally-known storage media library array apparatus arranged to merely reissue the predetermined command for re-executing only the particular operation during which the drive failure has been detected (i.e., which has been suspended due to the drive failure), the drive failure can often not be appropriately remedied, resulting in significant inconveniences. Namely, in many cases, the drive failure can not be appropriately recovered from or remedied by the conventional drive-failure recovery operation based on the re-execution of the suspended operation by the command reissuance, so that the overall working efficiency of the storage media library array apparatus would be greatly lowered accordingly.

### SUMMARY OF THE INVENTION

It is therefore an object of the present invention to provide a technique which, when there has occurred a drive failure that can not be remedied by only reissuing a predetermined command, can promptly recover from the drive failure by automatically performing various drive-failure recovery operations other than the command reissuance.

In order to accomplish the above-mentioned object, the present invention provides an improved method for recovering from a drive failure in a storage media library array apparatus, the storage media library array apparatus including a plurality of library units operable in a parallel fashion to write and/or read data concurrently to and/or from a designated group of storage media, each of the library units including a storage section for storing a plurality of storage media, a holder/transporter for holding and transporting a designated storage medium to a designated place in the library unit and a drive device for writing or reading data to or from a designated storage medium. The inventive method is directed to recovering from a drive failure occurring in a particular one of the drive devices of the library units when the designated storage medium is being transferred into or from the particular drive device or is being mounted in the particular drive device. To this end, the method of the present invention executes drive-failure recovery processing which comprises: a first step of performing an operation for physically moving the storage medium relative to the particular drive device to be recovered from the drive failure; a second step of performing a reboot operation on the particular drive device; a third step of performing a hard reset operation on the particular drive device; and a fourth step of performing an operation for turning off and then again turning on power to the particular drive device. In this invention, the operations of the first to fourth steps are sequentially carried out in predetermined order until the particular drive device appropriately recovers from the drive failure, in such a manner that once the particular drive device has successfully recovered from the drive failure through any of the operations of the first to fourth steps, the drive-failure recovery processing is brought to an end without performing the operation of the remaining step.

The operations of the first to fourth steps can effectively cope with various types of possible drive failures in the storage media library array apparatus; that is, depending on a particular nature of the detected drive failure, any one of the operations of the first to fourth steps can be executed to singly provide a “positive” solution or remedy for the detected drive failure. Namely, when a drive failure has occurred in a particular drive device, the present invention allows the particular drive device to appropriately recover from the drive failure, with a significantly increased possibility, by attempting various positive remedies, rather than the conventional “passive” remedy consisting of merely reissuing a predetermined command (re-executing the commanded operation). By sequentially carrying out the various different drive failure recovering remedies, rather than resorting to just one remedy, the present invention can significantly enhance the possibility of the drive device successfully recovering from the drive failure, and the overall working efficiency of the storage media library array apparatus can be enhanced accordingly.

The present invention may be constructed and implemented not only as the method invention as discussed above but also as an apparatus invention. Also, the present invention may be arranged and implemented as a software program for execution by a processor such as a computer or DSP, as well as a storage medium storing such a program. Further, the processor used in the present invention may comprise a dedicated processor with dedicated logic built in hardware, not to mention a computer or other general-purpose type processor capable of running a desired software program.

While the embodiments to be described herein represent the preferred form of the present invention, it is to be understood that various modifications will occur to those skilled in the art without departing from the spirit of the invention. The scope of the present invention is therefore to be determined solely by the appended claims.

### BRIEF DESCRIPTION OF THE DRAWINGS

For better understanding of the object and other features of the present invention, its preferred embodiments will be described in greater detail hereinbelow with reference to the accompanying drawings, in which:

FIG. 1 is a perspective view showing an exemplary general setup of a storage media library array apparatus to which a drive-failure recovery method of the present invention is applied;

FIG. 2 is an enlarged perspective view showing a general construction of each one of a plurality of library units in the storage media library array apparatus shown in FIG. 1;

FIG. 3 is a flow chart showing an embodiment of drive-failure recovery processing carried out in the library array apparatus when a drive failure is detected; and

FIG. 4 is a conceptual diagram explanatory of a series of operations performed by a holder/transporter and a drive device for reading or writing data on a storage medium, of which section (a) is a sectional side view schematically showing a medium loading transfer operation, section (b) is a sectional side view schematically showing a medium loading operation, section (c) is a sectional side view schematically showing a data read/write starting operation performed on a storage medium, section (d) is a sectional side view schematically showing a medium unloading operation, and section (e) is a sectional side view schematically showing a medium unloading transfer operation.

### DETAILED DESCRIPTION OF THE PREFERRED EMBODIMENTS

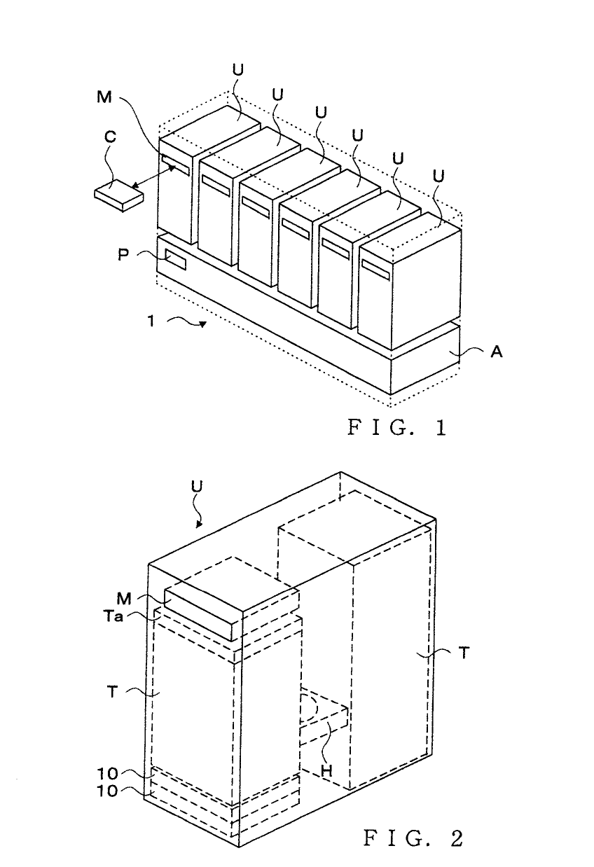

FIG. 1 is a perspective view showing an exemplary general setup of a storage media library array apparatus to which a drive-failure recovery method of the present invention is applied. FIG. 2 is an enlarged perspective view showing a general construction of each one of a plurality of library units (six library units in the illustrated example) U disposed side by side or as a horizontal array in the library array apparatus shown in FIG. 1; only one of the library units U is shown representatively in FIG. 2 because the library units U are identical in construction to each other. Note that the term “medium” or “media” used in the following description may be construed as meaning a transportable storage medium or media plus a tray supporting thereon the medium or media, rather than the storage medium or media alone.

In response to various instructions, such as data read/write instructions, given to an array controller A of the library array apparatus from a control panel P or from a not-shown higher-order control apparatus (e.g., personal computer) via a not-shown control interface (such as a SCSI interface), the library array apparatus concurrently activates the plural (six in the illustrated example) library units U in a parallel fashion, so as to concurrently carry out, at a high speed, a data read/write operation on media inserted or mounted in respective drive devices of the units U. The above-mentioned array controller A employed in the instant embodiment comprises a microcomputer that includes a CPU, ROM, RAM, etc. (all not shown), which, in accordance with various control instructions given from the control panel P or higher-order control apparatus, controls the individual library units U in a parallel fashion so that the respective drive devices 10 (FIG. 2) of the library units U are activated in parallel to concurrently perform a data read/write operation on designated media transported to and mounted in the drive devices 10. Namely, the array controller A issues various commands to each of the library units U to control the drive device 10, holder/transporter H, etc. in the library unit U.

As shown in FIG. 2, each of the library units U constituting the library array apparatus 1 includes: a storage section T having a multiplicity of storage shelves or slots Ta for storing a multiplicity of media (only one storage shelf Ta is shown for simplification of illustration); one or more (two in the illustrated example) drive devices 10 each capable of writing/reading data to/from a medium loaded or mounted therein; and a holder/transporter (changer) H for holding and transporting a designated or desired medium to a designated location within the library unit U. In accordance with control instructions from the array controller A, each of the library units U controls the holder/transporter H to take out a desired medium from a predetermined one of the storage shelves or slots Ta in the storage section T and then transport and load the medium into one of the drive devices 10. Then, the drive device 10 is controlled to carry out a data read/write operation on the medium loaded therein. Namely, each of the library units U is constructed to perform the data read/write operation on the designated medium independently of the other library units. Further, a different read/write operation can also be performed on each RAID (Redundant Array of Inexpensive Disks) group by operating, in parallel, the plurality of drive drive devices 10 of the individual library units U.

Further, each of the library units U includes a mass entry port M facing a human operator, through which a cartridge C containing a plurality of media can be introduced from the outside into the library unit U or discharged out of the library unit U. Namely, the mass entry port M is constructed to allow the plurality of media to be collectively introduced or discharged into or from the library unit U while being held in the cartridge C. The plurality of media contained in the cartridge C introduced through the mass entry port M are transported via the holder/transporter H to the storage section T, where they are stored into respective storage shelves. In some cases, a desired one of the media is transported, via the holder/transporter H, from the cartridge C directly to the drive device 10, where a data read/write operation is performed on the medium. The use of the cartridge C allows a plurality of media to be collectively passed between the library unit U and the outside of the unit U, which is very convenient.

Although the media library array apparatus 1 according to the preferred embodiment is shown and described as including a total of six library units U, it may of course include any other plurality of library units than six. Further, although the media library array apparatus 1 is shown and described as including one holder/transporter H in each of the library units U, only one such holder/transporter H may be provided in the entire library array apparatus 1 for shared use among the library units U. Further, although each of the library units U is shown and described as including two drive devices 10, it may be equipped with any desired number of drive devices, such as only one. Furthermore, the embodiment is described here in relation to the case where the mass entry port M is constructed to allow the cartridge C containing a plurality of media to be introduced and discharged therethrough and a desired one of the media is transported between the cartridge C and the storage section T or drive device 10, the use of the cartridge C is not necessarily essential to the present invention, and a desired medium may be directly introduced through the mass entry port M.

When a data read/write operation is to be performed in the storage media library array apparatus 1, it is preferable that an arrangement be made for loading all of a plurality of media, to be read or write together, into the respective drive devices 10 of the individual library units U as appropriately as possible, because such an arrangement can effectively avoid an undesired “degenerative” operation. Namely, in a situation where one of the drive devices 10 of the individual library units U to be simultaneously used for data reading/writing has a driving trouble or failure that can not be appropriately remedied, a degenerative operation would generally take place. In such a degenerative operation, the data read/write operation is carried out using only the remaining or normally-functioning drive devices 10. When the degenerative operation is carried out, the data to be read/written by the failed drive device 10 can be recovered or reconstructed on the basis of the data read/written by the remaining, normally-functioning drive devices 10; however, the data recovery is very time-consuming. Namely, in the situation where there has occurred a drive failure that can not be appropriately remedied or recovered from, a great processing time would be consumed in the data recovery operation even though predetermined data can be recovered successfully, so that the time for the normal data read/write operation would be undesirably limited due to the time-consuming data recovery operation.

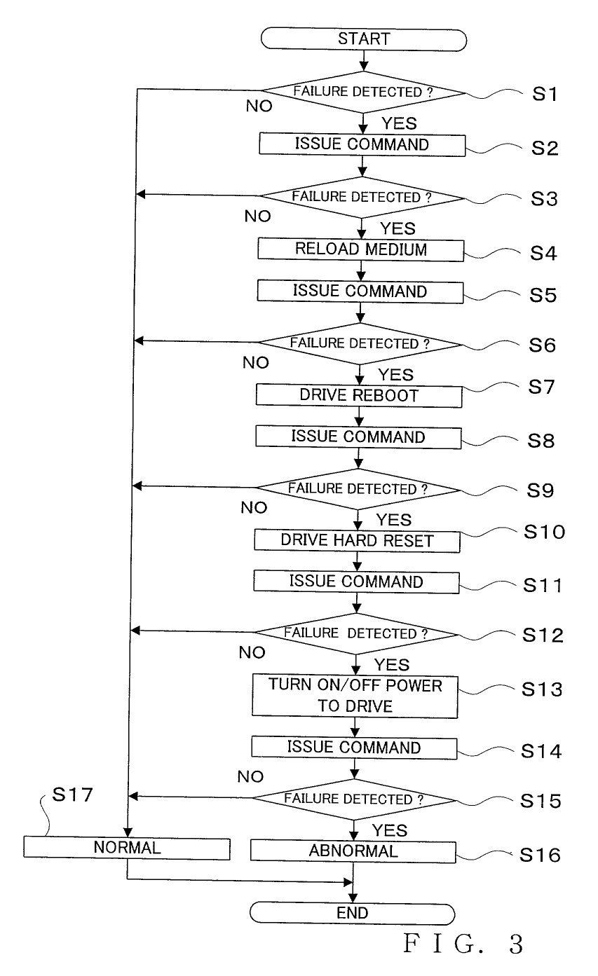

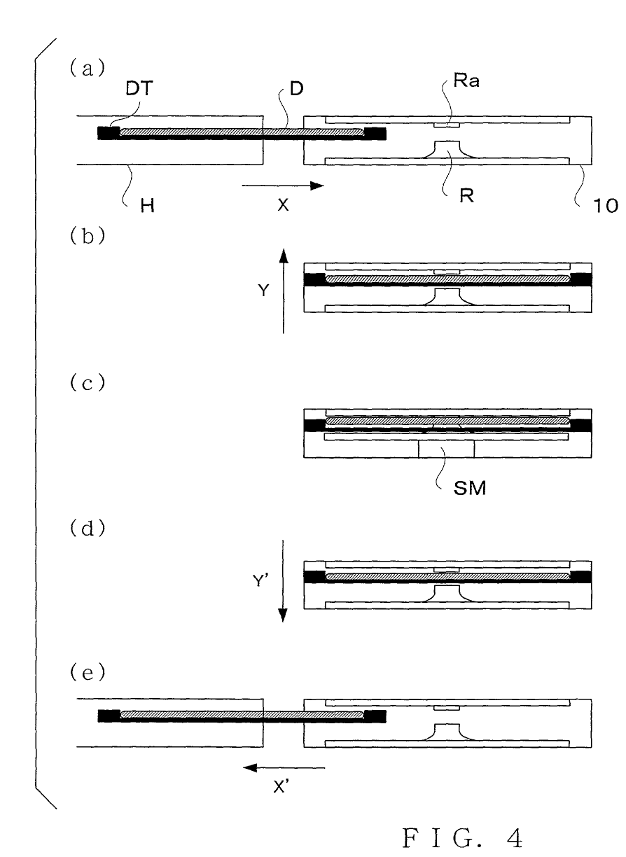

Therefore, the instant embodiment is arranged to sequentially perform various drive-failure recovery operations or schemes in order to maximize a chance of the drive failure being appropriately remedied and thereby completely eliminate a need for the above-mentioned degenerative operation or a possibility of the necessary data read/write operation being completely prevented from being performed. The following paragraphs describe drive-failure recovery processing performed in the instant embodiment when a drive failure occurs and is detected in any one of the library units U, with reference to FIG. 3 which is a flow chart showing an embodiment of the drive-failure recovery processing. When a drive failure is detected in executing an operation based on a predetermined command, such as the loading transfer command, load command, data read/write start command, unload command or unloading transfer command, this drive-failure recovery processing is carried out to recover from the detected drive failure and thereby re-execute the operation based on the command.

At first step S1 of the drive-failure recovery processing, a determination is made as to whether or not a drive failure has been detected, i.e. whether or not any of the designated drive devices in the library units has failed to appropriately carry out the predetermined operation when the loading transfer command, load command, data read/write start command, unload command or unloading transfer command has been issued. If all of the designated drive devices in the library units have appropriately carried out the predetermined operation responsive to the issued command, no drive failure is detected and thus a negative (NO) determination is made at step S1, so that the drive-failure recovery processing is brought to an end after issuing a message “Normal Driving Condition” at step S17. If, on the other hand, any of the designated drive devices in the library units has failed to appropriately carry out the predetermined operation responsive to the issued command, a drive failure is detected and thus an affirmative (YES) determination is made at step S1, so that the command is reissued for re-execution of the operation responsive to the command at step S2. For example, if a drive failure is detected while the loading operation is carried out as shown in section (b) of FIG. 4, the load command is reissued so as to re-execute the loading operation. Similarly, if a drive failure is detected while the unloading transfer operation is carried out as shown in section (d) of FIG. 4, the unloading transfer command is reissued so as to re-execute the unloading transfer operation which was being executed at the time of the drive failure detection. In this way, the operation that was being carried out at the time of detection of the drive failure can be executed again.

If the drive failure has been judged to be no longer present as a result of the command reissuance and re-execution of the operation responsive to the reissued command (NO determination at step S3), the drive-failure recovery processing is brought to an end after issuing a message “Normal Driving Condition” at step S17. Conversely, if the drive failure has been judged to be still present despite execution of the command reissuance and re-execution of the operation, an affirmative (YES) determination is made at step S3, and the medium D is reloaded into the drive device 10 at step S4. After that, the command is re-issued and the operation that was being carried out at the time of the detection of the drive failure is re-executed one more time at step S5. Namely, for example, the medium D having been so far mounted in the drive device 10 is temporarily taken out from the drive device 10 into the holder/transporter H through the unloading transfer operation, and then is again loaded from the holder/transporter H into the drive device 10. After that, the operation that was being carried out at the time of the detection of the drive failure is re-executed. In an alternative, the loader section R is merely moved in the upward and downward directions. Namely, the loading operation as shown in section (b) of FIG. 4 and the unloading operation as shown in section (d) of FIG. 4 are carried out in an alternate fashion. For example, when the loader section R is not properly fitted in the central opening of the medium D, the operation of step S5 allows the medium D to be re-loaded into the drive device 10, or allows the loader section R to be properly fitted in the central opening of the medium D by moving the loader section R in the upward and downward directions (see section (c) of FIG. 4).

Once the drive failure has been judged to be no longer present as a result of the above-mentioned medium re-loading operation (NO determination at step S6), the drive-failure recovery processing is brought to an end after issuing a message “Normal Driving Condition” at step S17. Conversely, if the drive failure has been judged to be still present despite execution of the medium re-loading operation (YES determination at step S6), an operation for rebooting the drive device 10 is carried out at step S7. Namely, the processing based on a software program controlling the behavior of the drive device 10 is temporarily deactivated and then started up again. After that, the operation that was being carried out at the time of the detection of the drive failure is re-executed at step S8.

Once the drive failure has been judged to be no longer present as a result of the above-mentioned rebooting of the drive device 10 (NO determination at step S9), the drive-failure recovery processing is brought to an end after issuing a message “Normal Driving Condition” at step S17. Conversely, if the drive failure has been judged to be still present despite execution of the rebooting of the drive device 10 (YES determination at step S9), an operation for hard-resetting the drive device 10 is carried out at step S10. Namely, the drive device 10 is reset without the power being completely turned off by receiving a hard-resetting instruction from the higher-order control apparatus or control panel P, and then started up (powered up) again. After that, the operation that was being carried out at the time of the detection of the drive failure is re-executed at step S11.

Once the drive failure has been judged to be no longer present as a result of the above-mentioned hard-resetting of the drive device 10 (NO determination at step S12), the drive-failure recovery processing is brought to an end after issuing a message “Normal Driving Condition” at step S17. Conversely, if the drive failure has been judged to be still present despite execution of the hard-resetting of the drive device 10 (YES determination at step S12), the power to the drive device 10 is turned off and then turned on again at step S13. Namely, by temporarily completely turning off the power to the failed drive device 10 and then turning on the power again, the failed drive device 10 is re-activated compulsorily. Because the power to the drive device 10 is temporarily shut off completely in this way, it can be ensured that the failed drive device 10 is restored to its complete initial state. After that, the operation that was being carried out at the time of the detection of the drive failure is re-executed at step S14.

Once the drive failure has been judged to be no longer present as a result of the above-mentioned power shutoff of the drive device 10 (NO determination at step S15), the drive-failure recovery processing is brought to an end after issuing a message “Normal Driving Condition” at step S17. Conversely, if the drive failure has been judged to be still present despite the turning ON/OFF the power to the drive device 10 (YES determination at step S15), the drive-failure recovery processing is brought to an end after issuing a message “Abnormal Driving Condition” at step S16.

With the above-described embodiments, even when a drive failure has been detected during the command-based operation, the drive failure can be remedied or recovered from appropriately, so that it is possible to minimize the number of loading failures of the medium to the drive device 10 and thereby minimize the possibility of the degenerative operation undesirably taking place.

It should be appreciated that the above-described drive-failure recovery processing may be carried out in any suitable order than the above-mentioned order. Further, all of the above-described drive-failure recovery schemes need not be executed as the drive-failure recovery processing, and an arbitrary combination of the foregoing drive-failure recovery schemes may be executed as the drive-failure recovery processing.

In summary, the present invention is characterized by performing various drive-failure recovery schemes to enhance the possibility of recovering from a detected drive failure. Hence, the present invention can reduce the possibility of the degenerative operation taking place as compared to the conventional techniques, and thus the overall working efficiency of the storage media library array apparatus can be significantly enhanced.

What is claimed is:

1. A method for recovering from a drive failure in a storage media library array apparatus, said storage media library array apparatus including a plurality of library units operable in a parallel fashion to write and/or read data concurrently to and/or from a designated group of storage media, each of said library units including a storage section for storing a plurality of storage media, a holder/transporter for holding and transporting a designated storage medium to a designated place in said library unit and a drive device for writing or reading data to or from a designated storage medium, said method being directed to recovering from a drive failure occurring in a particular one of the drive devices of said library units when the designated storage medium is being transferred into or from the particular drive device or is being mounted in the particular drive device, said method executing drive-failure recovery processing which comprises:
a first step of performing an operation for physically moving the storage medium relative to the particular drive device to be recovered from the drive failure;
a second step of performing a reboot operation on the particular drive device;
a third step of performing a hard reset operation on the particular drive device; and
a fourth step of performing an operation for turning off and then again turning on power to the particular drive device,
wherein the operations of said first to fourth steps are sequentially carried out in predetermined order until the particular drive device recovers from the drive failure in such a manner that once the particular drive device has successfully recovered from the drive failure through any of the operations of said first to fourth steps, said drive-failure recovery processing is brought to an end without performing the operation of the remaining step.

2. A method for recovering from a drive failure in a storage media library array apparatus, said storage media library array apparatus including a plurality of library units operable in a parallel fashion to write and/or read data concurrently to and/or from a designated group of storage media, each of said library units including a storage section for storing a plurality of storage media, a holder/transporter for holding and transporting a designated storage medium to a designated place in said library unit and a drive device for writing or reading data to or from a designated storage medium, said method being directed to recovering from a drive failure occurring in a particular one of the drive devices of said library units when the designated storage medium is being transferred into or from the particular drive device or is being mounted in the particular drive device, said method comprising:
a first process which executes any one of:
a first step of performing an operation for physically moving the storage medium relative to the particular drive device to be recovered from the drive failure;
a second step of performing a reboot operation on the particular drive device;
a third step of performing a hard reset operation on the particular drive device; and
a fourth step of performing an operation for turning off and then again turning on power to the particular drive device; and
a second process which, when the particular drive device can not recover from the drive failure despite execution of said first process, executes any one of the other steps than the step executed in said first process.

3. A method as claimed in claim 2 which further comprises a third process that, when the particular drive device can not recover from the drive failure despite execution of said second process, sequentially executes the other steps than the steps executed in said first and second processes until the particular drive device recovers from the drive failure.

4. A method for recovering from a drive failure in a storage media library array apparatus, said storage media library array apparatus including a plurality of library units operable in a parallel fashion to write and/or read data concurrently to and/or from a designated group of storage media, each of said library units including a storage section for storing a plurality of storage media, a holder/transporter for holding and transporting a designated storage medium to a designated place in said library unit and a drive device for writing or reading data to or from a designated storage medium, said method executing drive-failure recovery processing which comprises:
a first step of detecting whether a drive failure has occurred in a particular one of the drive devices of said library units when the designated storage medium is being transferred into or from the particular drive device or is being mounted in the particular drive device;
a second step of performing an operation for physically moving the storage medium relative to the particular drive device where the drive failure has been detected by said first step;
a third step of performing a reboot operation on the particular drive device;
a fourth step of performing a hard reset operation on the particular drive device; and
a fifth step of performing an operation for turning off and then again turning on power to the particular drive device; and
a sixth step of, upon detection of the drive failure by said first step, causing the operations of said second to fifth steps to be sequentially carried out in given order until the particular drive device recovers from the drive failure in such a manner that once the particular drive device has successfully recovered from the drive failure through any of the operations of said second to fifth steps, said drive-failure recovery processing is brought to an end without performing the operation of the remaining step.

5. A machine-readable program storage medium containing a group of instructions to cause said machine to perform a method for recovering from a drive failure in a storage media library array apparatus, said storage media library array apparatus including a plurality of library units operable in a parallel fashion to write and/or read data concurrently to and/or from a designated group of storage media, each of said library units including a storage section for storing a plurality of storage media, a holder/transporter for holding and transporting a designated storage medium to a designated place in said library unit and a drive device for writing or reading data to or from a designated storage medium, said method executing drive-failure recovery processing which comprises:
a first step of detecting whether a drive failure has occurred in a particular one of the drive devices of said library units when the designated storage medium is being transferred into or from the particular drive device or is being mounted in the particular drive device;
a second step of performing an operation for physically moving the storage medium relative to the particular drive device where the drive failure has been detected by said first step;
a third step of performing a reboot operation on the particular drive device;
a fourth step of performing a hard reset operation on the particular drive device; and
a fifth step of performing an operation for turning off and then again turning on power to the particular drive device; and
a sixth step of, upon detection of the drive failure by said first step, causing the operations of said second to fifth steps to be sequentially carried out in given order until the particular drive device recovers from the drive failure in such a manner that once the particular drive device has successfully recovered from the drive failure through any of the operations of said second to fifth steps, said drive-failure recovery processing is brought to an end without performing the operation of the remaining step.

6. A storage media library array apparatus comprising a plurality of library units operable in a parallel fashion to write and/or read data concurrently to and/or from a designated group of storage media, each of said library units including a storage section for storing a plurality of storage media, a holder/transporter for holding and transporting a designated storage medium to a designated place in said library unit, and a drive device for writing or reading data to or from a designated storage medium, said storage media library array apparatus further comprising a controller that performs:
control for detecting whether a drive failure has occurred in a particular one of the drive devices of said library units when the designated storage medium is being transferred into or from the particular drive device or is being mounted in the particular drive device; and
control for, upon detection of the drive failure, executing a plurality of recovery operations in given order until the particular drive device recovers from the drive failure, said plurality of recovery operations including:
a first operation of physically moving the storage medium relative to the particular drive device where the drive failure has been detected by said first step;
a second operation of rebooting the particular drive device;
a third operation of hard-resetting the particular drive device; and
a fourth operation of turning off and then again turning on power to the particular drive device.
